(19) United States
(12) Patent Application Publication
(10) Pub. No.: US 2006/0215888 A1
(43) Pub. Date: Sep. 28, 2006

(54) Method and apparatus of displaying of a medical image

(76) Inventors: Raymond Joseph Elisabeth Habets, Eindhoven (NL); Pieter Jaspers, Eindhoven (NL); Hubrecht Lambertus Tjalling De Bliek, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/541,403

(22) PCT Filed: Jan. 12, 2004
(86) PCT No.: PCT/IB04/50006

§ 371 Date: Jul. 1, 2005

(30) Foreign Application Priority Data
Jan. 13, 2003 (EP) 03075077.2

(51) Int. Cl. G06K 9/00

(52) U.S. Cl. 382/128; 382/154; 715/961

(57) ABSTRACT

The invention relates to a method of displaying of a medical, image, the method comprising the steps of: rendering of three dimensional image data on a display unit, selection of a picture element, determining a distance of a volume element corresponding to the picture element from a reference plane, scaling the size of a symbol based on the distance, displaying of the scaled symbol at or in the proximity of the selected picture element.

The present invention relates to the field of imaging, and more particularly to imaging of three dimensional medical data.

A variety of imaging techniques for rendering of three dimensional medical image data is known from the prior art. An example is the maximum intensity projection (MIP) technique. Various other volume rendering techniques are for example known from:

Cline, H. E.; Dumoulin, C. L.; Hart, H. R., Jr.; Lorensen, W. E. ; & Ludke S. (1987). “3D Reconstruction Of The Brain From Magnetic Resonance Images Using A Connectivity Algorithm”, Magnetic Resonance Imaging, Vol. 5, pp 345-352, 1987,

Rubin, D. Geoffrey; Dake, D. Michael; Napel, Sandy R. Brooke Jeffrey, Jr; McDonnell, H. Charles; Sommer, F. Graham; Wexler, Lewis; & Williams, M. David (1994) “Spiral CT of Renal Artery Stenosis: Comparison of Three-Dimensional Rendering Techniques”, Radiology, 190, pp. 181-189, 1994,

Halpern, J. Ethan; Wechsler, J. Richard; & DiCampli, Dennis(1995). “Threshold Selection for CT Angiography Shaded Surface Display of the Renal Arteries”, Journal of Digital Imaging, Vol. 8, No 3(August), 1995: pp 142-147.

In general such volume rendering techniques enable the selection of a reference plane which defines a view and/or a projection direction. Typically such volume rendering techniques are embedded in a software environment which provides an interactive graphical user interface for viewing and annotating of medical images.

For example, VolumeView is a three-dimensional environment for processing, correlating and comparing multiple volume data sets. VolumeView is a tool that is part of the EasyVision Platform which is commercially available from Philips especially for usage with Philips systems. To tool is used with a range of advanced processing packages, including full-volume MPR, 3D volume and surface rendering, CT Angio, CT/MR matching and Endo 3D.

Such software environments provide a graphical user interface for inputting landmarks and labels (symbols), in particular for annotating a medical image. Such symbols can be inputted manually by a radiologist or they can be computer generated by means of a computer aided diagnosis (CAD) tool.

It is a common disadvantage of prior art display methods that the display of such symbols in the medical image is not sufficiently intuitive such that there is a need for improvement.

The present invention provides for a method of displaying of a medical image with one or more additional symbols. The symbols can have various purposes such as the identification of suspicious regions for cancer diagnosis, marking of other regions of interest and/or providing a label for inputting an annotation. Further a pair of symbols can be used to mark the start and the end of a line within the rendered image. Further the symbols can be used to mark the edges of geometrical bodies such as bricks or cubes or other volumes.

The present invention is particularly beneficial as the scaling of the symbol size depending on the distance of the marked image region from the reference plane results in an intuitive display of the symbols in relation to the rendered image data. Due to the scaling of the size of the symbols proportional to the distance from the reference plane a spatial impression or depth perception is created which intuitively relates the symbols to corresponding regions of the rendered image. This way it can be avoided that the user has to interact with the image (for example rotate it) in order to properly interpret the position of the annotated symbols; further errors in the interpretation of the annotations can be prevented.

In accordance with a preferred embodiment of the invention the scaling of the size of a symbol is proportional to the distance of the symbol from the reference plane. When the distance is large this can result in a size of the symbol which can hardly be seen on the display by the radiologist. In order to prevent such a loss of information there is a predefined minimum size of the symbol.

In accordance with a further preferred embodiment of the invention a shortest and a largest distance of the picture elements of the rendered image from the reference plane is determined. This distances are also referred to as highest and lowest depth. The difference between the shortest and largest distances provides a scale for scaling of the size. For example if a picture element at the shortest distance is selected the symbol is displayed with a predefined maximum size. This predefined maximum size is the full size of the symbol. If a picture element having the largest distance from the reference plane is selected the symbol is displayed having a minimum size at this position. In other words: The symbol with the highest depth is displayed with the minimum size, the symbol with the lowest depth is displayed with the full size and all symbols in between are scaled relative to these extrema.

In general, the distance to the reference plane is a signed value (because the reference plane can be positions inside the volume). Positive values are behind the reference plane, negative values lie before the reference plane. This distance is also called depth (with a positive depth behind the reference plane, with negative values before the plane and 0 meaning inside the reference plane).

In essence this depth is used to scale the landmarks (the smaller the depth, the closer to the viewer, the larger the symbol used to visualize it).

For picture elements having a distance from the reference plane between the shortest and largest distances the resulting size of the symbol is between the fill size and the minimum size. For example a linear scale is used for reducing the size from the full size to the minimum size inversely proportional to the distance from the reference plane.

In accordance with a further preferred embodiment of the invention the user can change the view of the rendered object by shifting the reference plane or by rotating the volume. When such an operation occurs a corresponding resealing of the sizes of the symbols is performed in order to maintain the visualized spatial relationship between regions of interest in the rendered image data and the symbols.

In case the center of rotation equals a symbol (landmark) the size of that symbol should stay the same (in this case the symbol is located inside the reference plane). The scaling should then be relative to this symbol and the defined minimum and maximum symbol size.

The invention can be employed for all volume rendering techniques, in particular for perspective volume rendering and for parallel rendering (used for example with MIP). The invention enables to use the natural depth perception by size (present in perspective viewing) with landmarks (and labels) in perspective as well as perpendicular views.

In the following preferred embodiments of the invention will be described in greater detail by making reference to the drawings in which:

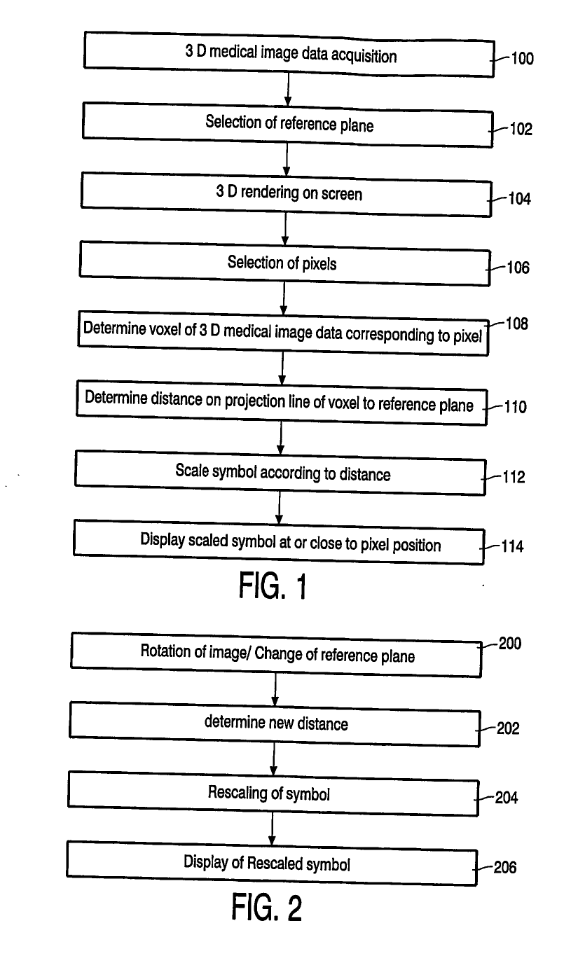

FIG. 1 is a flow chart being illustrative of an embodiment of a method of the invention,

FIG. 2 is illustrative of a method for resealing the sizes of the symbols when a change of the reference plane occurs,

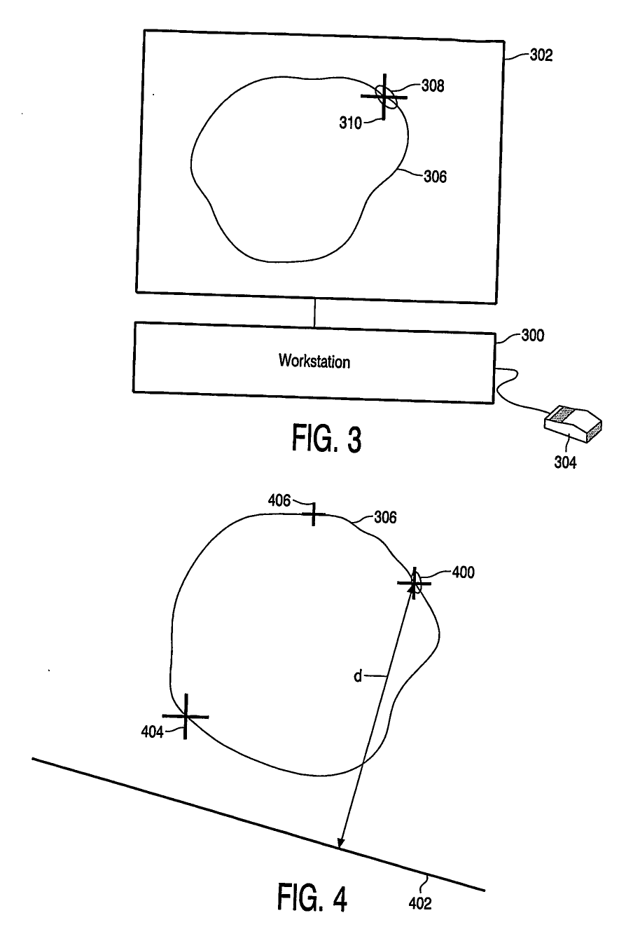

FIG. 3 shows a block diagram of a medical workstation illustrating the selection of a picture element,

FIG. 4 is a schematic diagram illustrating the determination of a distance from the reference plane,

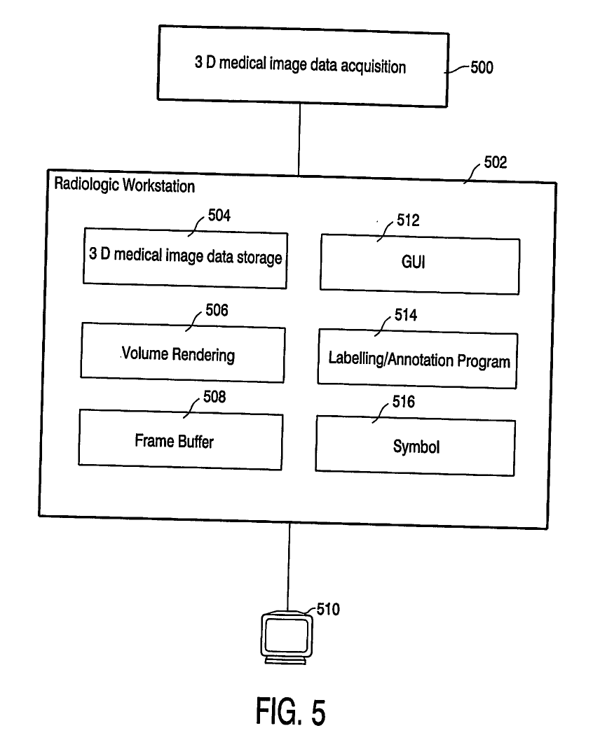

FIG. 5 is a more detailed block diagram of a medical workstation.

FIG. 1 shows a flow chart illustrating the steps performed for rendering of three dimensional image data and displaying of one or more symbols being related to the rendered image data. In step 100 a data acquisition step is performed for acquiring of three dimensional medical image data. For this purpose any suitable data acquisition technique can be used, such as computer tomography (CT), magnetic resonance imaging (MRI) or others. Usually such three dimensional medical image data is provided in the DICOM format. Basically the three dimensional medical image data contains a three dimensional array of voxels.

In step 102 a reference plane is selected by a user for viewing of the image from a certain view angle or perspective. In step 104 the three dimensional medical image data is rendered on a screen on the basis of the reference plane selected in step 102. For example, in case of MIP the reference plane defines the direction of the projection lines to perform the MIP.

In step 106 a pixel or a set of pixels is selected as a region of interest. This can be done automatically by software, such as by a computer aided diagnosis (CAD) tool or manually by a radiologist. Preferably the manual selection of such a region of interest is done interactively by means of a graphical user interface, such as by clicking on the region of interest with a computer mouse.

In step 108 the voxel of the three dimensional medical image data corresponding to the selected pixel is determined in order to determine the depth or distance of that voxel from the reference plane on the projection line. This is done in step 110. In step 112 the symbol is scaled in proportion to this distance.

When the symbol is far in the background at a large distance from the reference plane the size of the symbol is reduced correspondingly whereas when the symbol is in the foreground its size is larger. This way a spatial impression is created which relates the symbols to regions of interest of the rendered object. In step 114 the display of the scaled symbols is added to the rendering of the original image data.

FIG. 2 is illustrative of the process when the reference plane is changed such as by rotation of the image or by otherwise changing of the reference plane. Such a change is performed in step 200. In step 202 the new distance from the symbol to the reference plane is determined analogously to the determination of the distance in steps 108 and 110 of FIG. 1. In step 204 the size of the symbol is rescaled on the basis of the new distance. The resealed symbol is displayed in step 206 at or close to the region of interest to which it has been originally assigned.

This way the intuitive relation of the symbols to the respective regions of interest is maintained even if the image is rotated or when the reference plane is otherwise changed.

FIG. 3 shows a workstation 300 with a screen 302 for viewing of medical images. Workstation 300 has a graphical user interface with a computer mouse 304 as an input device. Alternatively other input devices such as a trackball, light pen etc. can be used.

Medical object 306 is displayed on screen 302 by means of a volume rendering technique. By means of computer mouse 304 the radiologist can select a region of interest 308 of medical object 306. In response a symbol 310 is displayed on screen 302 at the position of the region of interest 308. The size of symbol 310 is determined by workstation 300 in accordance with the principles as explained with respect to FIGS. 1 and 2.

In addition a label can be assigned to symbol 310 which enables to input an annotation. The size of the label can be scaled the same way as the size of symbol 310.

FIG. 4 is illustrative of the three dimensional image data which has been acquired for medical object 306. The three dimensional image data is a three dimensional array of voxels. FIG. 4 illustrates a two dimensional slice of the three dimensional array of voxels. Each of the picture elements (pixels) of the display of medical object 306 on screen 302 (cf. FIG. 3) has a one to one relationship to a voxel of the three dimensional image data. For example the region of interest 308 corresponds to the voxel region 400.

Further FIG. 4 schematically shows a reference plane 402 which is used for the volume rendering of FIG. 3.

The voxel region 400 has a distance d from the reference plane 402. This distance d is the basis for scaling the size of the symbol 310. Distance d is a signed value which is important when the reference plane 402 is inside medical object 306.

When another region of interest is selected on screen 302 corresponding to voxel 404 the size of symbol 310 is increased correspondingly. When a pixel corresponding to voxel 406 is selected as the position of the symbol the size of the symbol is further reduced as voxel 406 has a larger distance from the reference plane 402.

FIG. 5 shows a block diagram of a corresponding medical imaging system. The system has imaging system 500 for acquisition of three dimensional medical image data. The three dimensional medical image data is provided from imaging system 500 to medical workstation 502. Workstation 502 has mass storage 504 for storage of the image data provided from imaging system 500. Further workstation 502 has a program module 506 to provide a volume rendering technique for the three dimensional image data of storage 504. Further a frame buffer 508 is provided for storing of the resulting two dimensional image data for display on display unit 510 connected to workstation 502. Instead of a display unit 510 a printer can also be used as an output means.

Further workstation 502 has a graphical user interface 512 and a program module 514 for inputting of symbols for labeling and/or annotating of the medical images. Storage 516 serves to store one or more symbols for the purposes of labeling and/or annotating the medical images. The symbols stored in storage 516 have a predefined size.

By means of graphical user interface 512 a user can select a pixel or a region of interest as explained above for marking of that region of interest with a symbol. Program module 514 scales the size of the symbol based on the distance of the region of interest from the reference plane in accordance to the principles as explained above with reference to FIGS. 1 to 4.

LIST OF REFERENCE NUMBERS:

| | |
|---|---|
| 300 | workstation |
| 302 | screen |
| 304 | computer mouse |
| 306 | medical object |
| 308 | region of interest |
| 310 | symbol |
| 400 | voxel region |
| 402 | reference plane |
| 404 | voxel |
| 406 | voxel |
| 500 | imaging system |
| 502 | workstation |
| 504 | storage |
| 506 | program module |
| 508 | frame buffer |
| 510 | display unit |
| 512 | graphical user interface |
| 514 | program module |
| 516 | storage |

1. A method of displaying of a medical image, the method comprising the steps of:
rendering of three dimensional volume data on a display unit,
selection of a picture element,
determining a signed distance of a volume element corresponding to the picture element from a reference plane,
scaling the size of a symbol based on the distance,
displaying or printing of the scaled symbol at or in the proximity of the selected picture element.

2. The method of claim 1, whereby a minimum symbol size is defined which limits the reduction of the size of the symbol.

3. The method of claim 1 further comprising determining a shortest distance and a largest distance of the displayed picture elements from the reference plane to provide a scale for scaling of the size.

4. The method of claim 1, further comprising the steps of:
changing a view for rendering of the three dimensional image data,
determining of a second signed distance of the volume element corresponding to the selected picture element from the reference plane,
resealing of the size of the symbol based on the second distance,
displaying or printing of the rescaled symbol at or in the proximity of the picture element.

5. Computer program product, in particular digital storage medium, comprising computer program means for performing the steps of:
rendering of three dimensional image data on a display unit,
selection of a picture element,
determining a distance of a volume element corresponding to the picture element from a reference plane,
scaling the size of a symbol based on the distance,
displaying or printing of the scaled symbol at or in the proximity of the selected picture element.

6. Computer system for processing of medical image data comprising:
means for rendering of three dimensional image data on a display unit,
means for selection of a picture element,
means for determining a distance of a volume element corresponding to the picture element from a reference plane,
means for scaling the size of a symbol based on the distance,
means for displaying or printing of the scaled symbol at or in the proximity of the selected picture element.

7. The computer system of claim 6 further comprising means for determining a shortest distance and a largest distance of the displayed picture elements from the reference plane to provide a scale for scaling of the size.

8. Computer system of claim 6 further comprising:
means for changing a view for rendering of the three dimensional image data,
means for determining of a second distance of the volume element corresponding to the selected picture element from the reference plane,
means for resealing of the size of the symbol based on the second distance.

9. Medical imaging system comprising:
means for three dimensional medical image data acquisition,
means for means for rendering of three dimensional image data on a display unit,
means for selection of a picture element,
means for determining a distance of a volume element corresponding to the picture element from a reference plane,
means for scaling the size of a symbol based on the distance,
means for displaying or printing of the scaled symbol at or in the proximity of the selected picture element.
